(19) United States
(12) Patent Application Publication
(10) Pub. No.: US 2006/0213631 A1
(43) Pub. Date: Sep. 28, 2006

(54) Staining prevention method for dry part of paper machine and staining inhibitor used for the method

(76) Inventor: Hiroshi Sekiya, Tokyo (JP)

Correspondence Address: FLYNN THIEL BOUTELL & TANIS, P.C., 2026 RAMBLING ROAD, KALAMAZOO, MI, 49008-1631, US

(21) Appl. No.: 10/552,517

(22) PCT Filed: Mar. 29, 2004
(86) PCT No.: PCT/JP04/04462

§ 371 Date: Oct. 7, 2005

(30) Foreign Application Priority Data
Apr. 9, 2003 (JP) 2003-105630

(51) Int. Cl. D21H 23/00; C08L 91/00

(52) U.S. Cl. 162/184; 162/199; 106/285; 106/244; 526/317.1

(57) ABSTRACT

A simple method capable of effectively preventing dry part areas, at least the surfaces of cylindrical dryers, from being stained even if a spray space is absent in a paper machine. The method can prevent the contact part of the dry part (D) of the paper machine with a paper body from being stained. The dry part staining prevention method can continuously feed/apply a staining inhibitor (T) to the paper body (W) at a position just before the dry parts.

### FIELD OF THE INVENTION

The present invention relates to a contamination-preventing method in a paper machine, and in particular to a method for preventing contamination of a portion contacting with a paper web in a dry part of a paper machine.

### BACKGROUND ART

A paper machine is provided with a drying step based upon a principle of heating for removing moisture, so called dry part.

The dry part is provided with a plurality of cylindrical dryers for drying wet paper webs, and it occupies major part of the paper machine.

In the paper machine, when non-dried paper containing moisture is supplied to the dry part, this paper is pressed on a surface of a cylindrical dryer (which has a structure where heating is performed by causing steam to flow to inside thereof) by a canvas and is dried.

In general, since a surface of a cylindrical dryer made from metal is a fine rough face, and particularly a cylindrical dryer made from cast metal is broadly used, it can not be avoided that such a rough face occurs on a surface of paper.

Now, pitch or tar content, additives contained in various papers or foreign matter particles such as filler particles are contained in paper.

In recent years, especially, much waste paper is blended in raw material in view of recycling. Besides, there is a tendency that mixing of foreign matter particles such as fine fibers, hot melt, spine paste pitch made from vinyl acetate series increases.

When a paper adheres to a surface of a cylindrical dryer heated, such foreign matter particles become adhesive due to heat to be fixed on a surface of the cylindrical dryer to form contamination material thereon, thereby contaminating the cylindrical dryer.

According to increase in projection on a surface of a paper, such inclusion tends to be fixed on the cylindrical dryer surface relatively easily.

In order to remove contamination material fixed on the cylindrical dryer, a method for scraping the contamination material using a doctor blade which is an auxiliary device for the cylindrical dryer is usually used.

However, there is a problem that the cylindrical dryer surface is made further rough due to friction between the doctor blade and the dryer surface and the above foreign matter particles receive heat or pressure to enter in and fixedly adhere on the undulation portion on the rough surface.

As described above, foreign matter particles fixedly adhere on the cylindrical dryer, or simultaneously therewith, texture on a paper surface is scrapped, which results in direct or indirect adverse influence due to these foreign matter particles.

That is, the following specific defects occur.
1. Heat conductivity on a cylindrical dryer surface lowers, which results in reduction of a drying rate of paper.
2. Peeling-off of paper surface, a so-called “picking” phenomenon occurs easily.
3. Such a defect as re-transfer of foreign matter particles grown on a dryer occurs.
4. Burning adhesion of paper on a cylindrical dryer surface and paper breaking occurs.
5. Undulation, fuzz or the like is caused on a surface of paper to be made.
6. Since paper particles are mixed in a product or surface paper force is lowered, transfer blocking of ink to a paper surface especially at a printing time, so-called “void” phenomenon occurs.
7. The number of periodic cleanings for cylindrical dryer increases, which results in increase in cost.

From the above, such a countermeasure is adopted that a cylindrical dryer whose surface has been subjected to chrome-plating treatment, polytetrafluoroethylene treatment, or the like in advance is used or oil baking processing is periodically performed after machine stopping.

However, even in both the countermeasures, when a cylindrical dryer which has been subjected to surface treatment is used for a long period, a treated surface gradually wears due to friction, which results in considerable reduction in contamination-preventing effect.

Therefore, exchange to a new cylindrical dryer is required, which results in loss due to time for exchange and increase in excessive cost.

Accordingly, an effect over a long period can not be expected and continuous operation is improper for such a cylindrical dryer.

From these circumstances, an approach for solving these problems by spraying and applying contamination-preventing agent to a surface of a cylindrical dryer itself directly and continuously in a region of a dry part is adopted (see Patent Literature 1).

Though this method is considerably effective, a spatial margin in the dry part region may be insufficient necessarily depending on kinds of paper machines.

In some cases, such a problem that an equipment space for arranging an equipment (a spraying and applying device) for spraying and applying contamination-preventing agent can not be secured occurs.

Further, though an approach for reciprocating a spraying nozzle in an axial direction of a cylindrical dryer to apply contamination-preventing agent over an entire length of the cylindrical dryer evenly without discontinuity as much as possible is adopted in many spraying systems utilizing such a spraying and applying device, there is a technical limitation in the spraying and applying device. Therefore, when adhesive material (foreign matter particles) increases in raw material, blur may occur on a portion of the cylindrical dryer where contamination-preventing agent loses.

Further, the cylindrical dryer has a relatively large diameter, and it may be impossible to perform application over a whole surface of the cylindrical body evenly.

In such a situation, unevenness occurs regarding the contamination-preventing effect to the cylindrical dryer and fixation of foreign matter particles can not be prevented effectively, so that such a spraying system does not constitutes reliable contamination-preventing means necessarily.

Further, as described above, blending of waste paper as raw material increases, but much adhesive material (adhesive, sticky agent or the like) or foreign matter is included in waste paper in recent years, which results in easiness of transfer to a cylindrical dryer surface.

Patent Literature 1: JP-A-2000-96478

### DISCLOSURE OF THE INVENTION

[Problem to be solved by the Invention]

The present invention is directed to solving the above various problems.

That is, an object of the present invention is to provide a method which can prevents contamination in a region of a dry part, at least a cylindrical dryer surface effectively by a simple way even if a paper machine does not include a spraying space.

[Means for solving the Problem]

Thus, as a result of keen repeated by researches to these problems, the present inventors have found such a fact that a phenomenon that contamination material transfers from a paper web to a portion coming in contact with the paper web in a dry part, for example, a cylindrical dryer, can be prevented by supplying contamination-preventing agent on a surface of the paper web in a stage before the paper web enters in the cylindrical dryer instead of spraying and applying the contamination-preventing agent on a dryer surface, and they have completed the present invention based upon the finding.

That is, (1): the present invention lies in a method for preventing contamination of a contacting portion with a paper web in a dry part in a paper machine, where contamination-preventing agent is continuously supplied and applied to a paper web before entering in the dry part.

(2): The present invention lies in a contamination-preventing method in a dry part, where the continuous supplying and applying the contamination-preventing agent to the paper web is constituted by indirect application to the paper web via an applying roller.

(3) The present invention lies in a contamination-preventing method in a dry part, where the continuous supplying and applying of the contamination-preventing agent to the paper web is constituted by indirect application to the paper web via a guide roller.

(4) The present invention lies in a contamination-preventing method in a dry part, where the continuous supplying and applying of the contamination-preventing agent to the paper web is constituted by indirect application to the paper web via a felt or a wire.

(5) The present invention lies in a contamination-preventing method in a dry part, where the continuous supplying and applying of the contamination-preventing agent to the paper web is constituted by direct application to the paper web using a spraying nozzle.

(6) The present invention lies in a contamination-preventing method in a dry part, where oil is used as the contamination-preventing agent.

(7) The present invention lies in a contamination-preventing method in a dry part, where the oil is mineral oil, vegetable oil, animal oil, or synthetic oil.

(8) The present invention lies in a contamination-preventing method in a dry part, where as the oil, one obtained by emulsifying oil using surface active agent is used.

(9) The present invention lies in a contamination-preventing method in a dry part, where polymer is used as the contamination-preventing agent.

(10) The present invention lies in a contamination-preventing method in a dry part, where the polymer serving as the contamination-preventing agent is ampholyte copolymer obtained by polymerizing mixture including cationic monomer having ethylene double bond and anionic monomer having ethylene double bond as essential components.

(11) The present invention lies in contamination-preventing agent used in the contamination-preventing method in a dry part described in the above item (1), which is obtained by emulsifying mineral oil, vegetable oil, animal oil, or synthetic oil using surface active agent.

(12) The present invention lies in contamination-preventing agent used in the contamination-preventing method for a dry part described in the above item (1), which is ampholyte copolymer obtained by polymerizing mixture including cationic monomer having ethylene double bond and anionic monomer having ethylene double bond as essential components.

(13) The present invention lies in contamination-preventing agent described in the above item (12), where the cationic monomer is monomer having ethylene double bond with amino groups, ammonium base, or quaternary ammonium base.

(14) The present invention lies in contamination-preventing agent described in the above item (12), where the anionic monomer is monomer having ethylene double bond with carboxyl groups or alkali metal salt thereof.

(15) The present invention lies in contamination-preventing agent described in the above item (12), where the cationic monomer is at least one (including only one, of course) selected from the group consisting of compounds which are (meta)acrylic acid esters such as (meta)acrylic acid 2-(N,N-dimethylamino)ethylmethylchloride salt, (meta)acrylic acid 2-(N,N-dimethylamino)ethylbenzylchloride salt, and (meta)acrylic acid 3-(N,N-dimethylamino)propylepichlorohydrin hydrochloride and which contain quaternry ammonium chlorine.

(16) The present invention lies in contamination-preventing agent described in the above item (12), where the anionic monomer is at least one (including only one, of course) selected from the group consisting of acrylic acid, methacrylic acid, itaconic acid, fumaric acid, succinic acid 2-(meta)acrylicoiloxyethyl, and hexahydrophthalate 2-(meta)acrylicoiloxyethyl.

(17) The present invention lies in contamination-preventing agent used for the contamination-preventing method for a dry part described in claim 1, which is ampholyte copolymer obtained by polymerizing mixture including cationic monomer having ethylene double bond, anionic monomer having ethylene double bond, and non-ionic (nonionic) monomer as essential components.

(18) The present invention lies in contamination-preventing agent described in the above item (17), where the cationic monomer is at least one (including only one, of course) selected from the group consisting of compounds which are (meta)acrylic acid esters such as (meta)acrylic acid 2-(N,N-dimethylamino)ethylmethylchloride salt, (meta)acrylic acid 2-(N,N-dimethylamino)ethylbenzylchloride salt, and (meta)acrylic acid 3-(N,N-dimethylamino)propylepichlorohydrin hydrochloride and which contain quaternry ammonium chlorine.

(19) The present invention lies in contamination-preventing agent described in the above item (17), where the anionic monomer is at least one (including only one, of course) selected from acrylic acid, methacrylic acid, itaconic acid, fumaric acid, succinic acid 2-(meta)acrylicoiloxyethyl, and hexahydrophthalate 2-(meta)acrylicoiloxyethyl.

(20) The present invention lies in contamination-preventing agent described in the above item (17), where the number of carbon atoms is in a range of 6 to 50 in the non-ionic (nonionic) monomer.

(21) The present invention lies in contamination-preventing agent described in the above item (17), where the non-ionic (nonionic) monomer is polyethyleneglycomono (meta)acrylate and/or polyproplyeneglycolomono(meta)acrylate.

(22) The present invention lies in a method for preventing contamination of a contacting portion with a paper web in a dry part in a paper machine, where contamination-preventing agent is continuously supplied and applied to a paper web before entering in the dry part, and contamination-preventing agent is further continuously supplied and applied to a portion of the dry part which comes in contact with a paper web.

(23) The present invention lies in the contamination-preventing method for a dry part described in the item (22), where the portion of the dry part which comes in contact with a paper web is a dryer, a canvas, a calendar roll, a smoother roll, or a paper roll.

(24) The present invention lies in contamination-preventing agent used for a contacting portion with a paper web in a dry part of contamination-preventing agent described in the item (22), which is obtained by emulsifying mineral oil, vegetable oil, animal oil, synthetic oil or wax using surface active agent.

The present invention can adopt any constitution obtained by combining two or more selected from the above items 1 to 24, if it satisfies the object of the present invention.

[Operation]

A sealing film is always formed and maintained so as to seal fine foreign matter particles on a surface of a paper web by continuously supplying and applying contamination-preventing agent on the surface of the paper web put before entering in a dry part.

Transfer of foreign matter particles from a paper web to a contacting portion with a paper web in a dry part, for example, a cylindrical dryer surface is prevented by the sealing film

[Effect of the Invention]

By supplying and applying contamination preventing agent to a paper web before the paper web enters in a dry part of a paper machine, a sealing film is formed on the paper and foreign matter particle contained in the paper web is sealed by the sealing film.

Since foreign matter particles do not come in direct contact with a portion coming in contact with a paper web, for example, a surface of a cylindrical dryer, transferring of the foreign matter particles does not occur, so that contamination of the cylindrical dryer is prevented.

Since a spraying and applying device is not disposed in a dry part, which is different from the conventional art, even if there is not a surplus space allowing arrangement of a spraying and applying device in the dry part, it is possible to prevent contamination of a portion coming in contact with a paper web, for example, a cylindrical dryer.

Contamination-preventing effect is prevented from being made uncertain due to occurrence of application unevenness, which is different from the case that contamination-preventing agent is directly sprayed and applied on a cylindrical dryer, so that contamination prevention is performed reliably.

Further, when contamination-preventing agent is continuously supplied and applied to a paper web before it enters in a dry part and contamination-preventing agent is continuously supplied and applied to a contacting portion coming with a paper web in the dry part of a paper machine such as the dryers, canvas, calendar-rolls and the like, contamination-preventing effect to a whole machine is further improved.

### BRIEF DESCRIPTION OF THE DRAWINGS

FIG. 1 shows a specific example of a method for preventing contamination of a cylindrical dryer in a paper machine of the present invention;

FIG. 2 shows a case that a roll coater is used as means for supplying and applying contamination-preventing agent indirectly;

FIG. 3 shows another example where a felt provided in a press part is used as the means for supplying and applying contamination-preventing agent indirectly;

FIG. 4 shows a case that a spraying device is used as means for supplying and applying contamination-preventing agent directly;

FIGS. 5A and 5B are views illustratively showing a section of a paper web after contamination-preventing agent has been applied to the paper web;

FIG. 6 shows experimental results showing a surface state of a dryer in Example 2; and

FIG. 7 is a diagram showing a wire part and a press part.

### BEST MODE FOR CARRYING OUT THE INVENTION

The present invention will be explained with reference to the drawings showing embodiments.

The present invention is directed to a technique that contamination-preventing agent is continuously supplied and applied to a paper web fed into a dry part in this paper machine so that a portion of the dry part which comes in contact with the paper web, for example, a cylindrical dryer or a canvas, is prevented from being contaminated.

Even if there is not a space for allowing arrangement of a device for supplying and applying contamination-preventing agent in a dryer part, sufficient effect can be achieved.

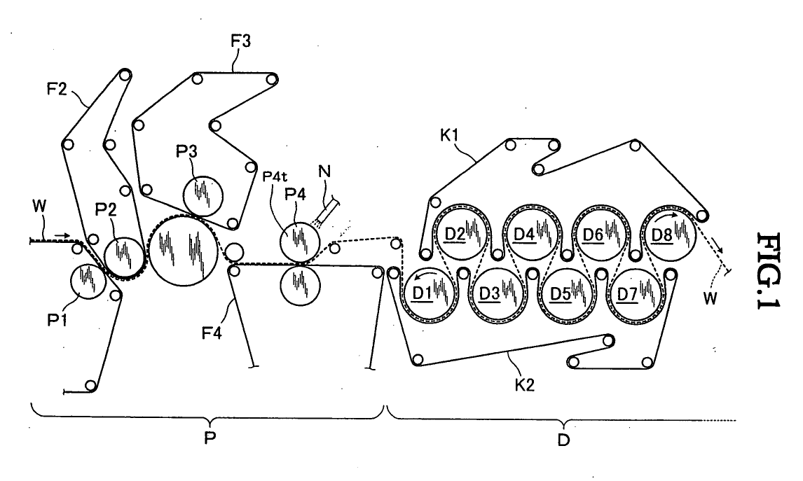

FIG. 1 shows one specific example of a method for preventing contamination of a portion coming in contact with a paper web in a dry part of a paper machine of the present invention, for example, a cylindrical dryer.

In the paper machine, a drying portion (dryer part D) is disposed subsequent to a press part P, and the drying part is provided with heated cylindrical dryers D1, . . . , canvases K1, . . . which press a paper web W on to the dryers, canvas rollers for guiding the canvases, and the like.

The press part P is provided with press rolls P1, . . . , and felts F2, . . . which press a paper web W on to the press rolls to absorb moisture.

In a method illustrated, contamination-preventing agent T is indirectly supplied and applied to a paper web W before it enters in the paper machine via a guide roller 1.

Incidentally, in the case illustrated, an example where a press roll disposed just before entering in the dry part is utilized as the guide roller.

Diluted liquid of contamination-preventing agent T is sprayed onto the guide roller 1 by a spraying and applying device (a spraying nozzle N), and contamination-preventing agent T adhered on a surface of this guide roller 1 is transferred to a paper web W.

At that time, as described later, the contamination-preventing agent T is formed as a sealing film T1 so as to seal foreign matter particles.

The paper web W applied with contamination-preventing agent T enters in the press part P where is squeezed and dehydrated by the press rolls, and thereafter it is sent to the dry part D where it is heated and dried.

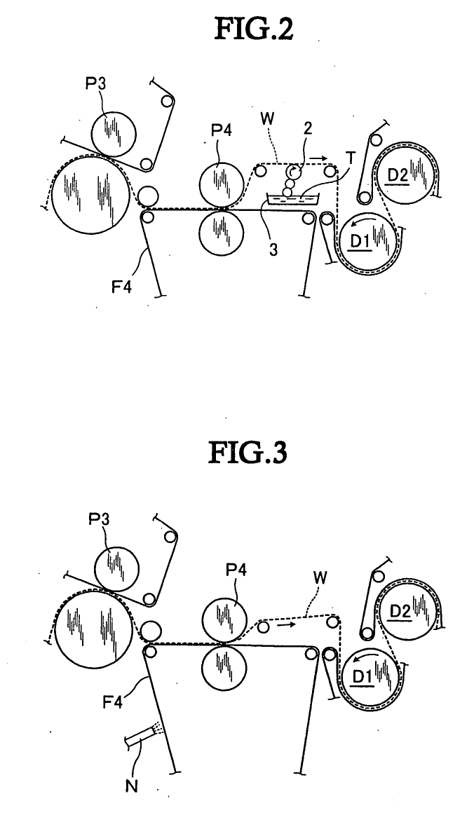

FIG. 2 shows another example that a roll coater process is used as means for supplying and applying contamination-preventing agent T indirectly.

Contamination-preventing agent T is applied from a contamination-preventing agent vessel 3 to a paper web W via an application roll 2.

FIG. 3 shows still another example that a felt provided in the press part P is uses as means for supplying and applying contamination-preventing agent T indirectly.

In that case, diluted solution of contamination-preventing agent T is applied to a felt F4 disposed nearest the dry part D, for example by a spraying nozzle N with a full width (so-called spray nozzle) and the applied agent is transferred to a paper web W.

In this FIG., the contamination-preventing agent T is transferred and applied to a back face of a paper web W.

The methods shown in FIG. 1, FIG. 2, and FIG. 3, described above are shown as methods for supplying and applying contamination-preventing agent T to a paper web W indirectly.

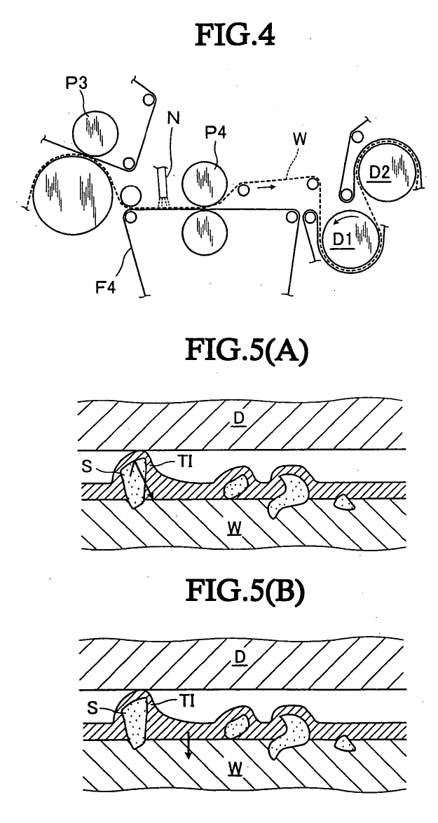

A method shown in FIG. 4 is directed to an example of a method for performing direct supplying and applying to a paper web W.

As the method for supplying and applying contamination-preventing agent used here, a method for supplying and applying the diluted solution of contamination-preventing agent T using a spraying nozzle with a full width is adopted.

Incidentally, in an ordinary paper machine, a relatively sufficient free space is formed in a region where the spraying nozzle N shown in FIG. 4 is disposed or in a region where the roll coater shown in FIG. 2 is disposed, which is different from the dry part.

[Contamination-Preventing Agent]

Now, oil or polymer is adopted as a specific contamination-preventing agent used in the present invention.

It is preferable that the oil is mineral oil, vegetable oil, animal oil, synthetic oil (including silicon oil), or the like, for example.

These oils may be used alone or in a combination manner thereof.

Since a dryer surface is heated to a high temperature (50° C. to 120° C.), oil which does not denature at that temperature is selected.

It is preferable that the oil is added with surface active agent to be emulsified with water so that spraying thereof is made easy, as described later.

Such a constitution is adopted that a blending ratio of surface active agent is in a range of 5 to 70 weight % to oil, and contamination-preventing agent added with water in an amount of 400 to 200000 times oil is used according to conditions such as a paper making speed, a paper width, a supplying and applying method of contamination-preventing agent in a specific applying way.

As described later, since the polymer (usually, polymer solution) must have a proper adhesive function to a paper web, ampholyte copolymer obtained by polymerizing mixture including cationic monomer having ethylene double bond and anionic monomer having ethylene double bond as essential components is much excellent in contamination-preventing property and is desirable.

The cationic monomer having ethylene double bond may include monomer having ethylene double bond with amino groups, ammonium base, or quaternary ammonium base.

Specifically, compounds which are (meta)acrylic acid esters such as (meta)acrylic acid 2-(N,N-dimethylamino)ethylmethylchloride salt, (meta)acrylic acid 2-(N,N-dimethylamino)ethylbenzylchloride salt, and (meta)acrylic acid 3-(N,N-dimethylamino)propylepichlorohydrin hydrochloride and which contain quaternry ammonium chlorine can be adopted. (Meta)acrylic acid 2-(N,N-dimethylamino)ethylmethylchloride salt, (meta) acrylic acid 2-(N,N-dimethylamino)ethylbenzylchloride salt is desirable form an effective aspect.

The anionic monomer having ethylene double bond may include monomer having ethylene double bond with carboxyl groups or alkali metal salt thereof.

Specifically, acrylic acid, methacrylic acid, itaconic acid, fumaric acid, succinic acid 2-(meta)acrylicoiloxyethyl, and hexahydrophthalate 2-(meta)acrylicoiloxyethyl, or the like can be adopted.

Acrylic acid or methacrylic acid is desirable from an effective aspect.

Further, in view of effect, it is more preferable to polymerize graphite chain-like material, for example, polyethyleneglycolmono (meta)acrylate and/or polypropyleneglycolmono(meta)acrylate, to the above-described ampholyte polymer as non-ionic (nonionic) monomer.

It is more preferable from an effective aspect that the number of carbon atoms is in a range of 6 to 50 as the non-ionic (nonionic) monomer.

Further preferably, material with the number of carbon atoms in a range of 10 to 40 develops higher effect.

Incidentally, it is preferable that the ampholyte polymer includes the cationic monomer in a weight percentage of 40% or more.

[Contamination-Preventing Principle]

Now, contamination-preventing agent T to be supplied and applied to a paper web W in the present invention is applied to a surface of a paper web so that it develops its original function when the paper web reaches the dry part D.

That is, the contamination-preventing agent T has such a function that foreign matter particle S (especially put in a projecting state) contained in the paper web W does not transfer to the dryer surface in the dry part D.

FIGS. 5A and 5B are views illustratively showing sections of paper webs after contamination-preventing agents T have been supplied and applied to the paper webs.

By supplying and applying contamination-preventing agent T to a paper web W, a sealing film T1 is formed to cover and seal foreign matter particle S put on a surface of the paper web in a projecting state.

When a paper web W comes in contact with a surface of the cylindrical dryer D which is a contacting portion in the dry part, since the paper web W comes in contact with the surface via the sealing film T1, the foreign matter particle S does not come in direct contact with the dryer surface.

Since the sealing film T1 develops a so-called “shielding function”, the foreign matter particle S is prevented from transferring to the cylindrical dryer surface to fixedly adhere thereto (see FIG. 5A).

The sealing film T1 having such a shielding function acts on the cylindrical dryer surface effectively when oil is used as the contamination-preventing agent T.

On the other hand, when a paper web W comes in contact with a surface of the cylindrical dryer D, since the sealing film T1 develops a function to be constrained by a paper web W, namely, “adhesive function”, the sealing film T1 captures foreign matter particle S strongly without peeling off, so that the foreign matter particle is prevented from transferring and fixing to the dryer (see FIG. 5B).

The sealing film T1 having adhesive function such as the latter serves to a dryer surface effectively when polymer is used as the contamination-containing agent T.

The principle described above can be applied to a canvas, of course.

Here, since it is required for a paper web applied in the present invention that the contamination-preventing agent T forms a sealing film, as described above, it goes without saying that the present invention can not be applied to a paper machine for making tissue.

This is because a sealing film such as the present invention can not be formed in paper quality such as tissue.

Now, as to a supply amount of contamination-preventing agent (for example, oil), the contamination-preventing agent can be supplied and applied to such an extent that a thin film is formed so as to seal foreign matter particles adhered to a paper web.

Further, such setting is employed that a supply amount of contamination-preventing agent to a surface of a paper web is in a range of 0.00001 mg/m² to 10 mg/m².

This range is effective in view of prevention of adverse influence to paper quality due to a formed state of a sealing film or an excessive film.

### Another Embodiment 1

As described above, the present invention is characterized in that contamination-preventing agent is continuously supplied and applied to a paper web before entering in the dry part. Further, by supplying and applying contamination-preventing agent to a contacting portion with a paper web (for example, a dryer, a canvas, a calendar roll, a guide roll, or the like) in the dry part, contamination-preventing effect to the whole machine can be further improved.

Incidentally, the calendar roll is generally arranged at an end section in the dry part and it is a portion which comes in pressure contact with a paper web to serve to improve flatness of a surface thereof or the like.

For example, the dryer and the canvas of contacting portions with a paper web in the dry part is especially a portion easily contaminated.

Therefore, by supplying and applying contamination-preventing agent to the dryer or the canvas continuously, the member itself is prevented from being contaminated (contamination-preventing agent can be supplied and applied to both the dryer and the canvas, of course).

As described in the conventional example, therefore, even if there is such a problem that a portion where contamination-preventing agent is absent occurs on the cylindrical dryer according to the increase of adhesive material (foreign matter particles) in the raw material due to technical limitation in the spraying and applying device, contamination-preventing agent has been supplied and applied to a paper web itself before entering in the dry part, any trouble does not occur.

Here, as the contamination-preventing agent to be supplied and applied to a contacting portion with a paper web in the dry part, for example, mineral oil, vegetable oil, animal oil, synthetic oil (including silicon oil or the like), wax, polymer, or the like can be used.

Incidentally, as means for performing supplying and applying to a dryer or a canvas, a spraying nozzle such as described previously can be used.

Further, contamination-preventing agent is diluted with water whose amount is 400 to 200000 times the agent in advance for performing spraying over a paper width evenly and it is distributed using a spraying nozzle with a full width.

### Another Embodiment 2

As described above, the present invention is characterized in that contamination-preventing agent is continuously supplied and applied to a paper web before entering in the dry part, but it can functionally achieve a similar effect on a roll (a paper roll or a smoother roll) positioned in a region defined to be included in the dry part region.

In that case, the expression “a paper web before entering in the dry part” means “a paper web before reaching a paper roll or a smoother roll”.

That is, it is necessary to supply and apply contamination-preventing agent to a paper web before reaching the paper roll or the smoother roll continuously.

With such a constitution, a sealing film is formed and foreign matter particles included in paper web are sealed.

By forming the sealing film, foreign matter particles are prevented from coming in direct contact with a surface of the paper roll and the smoother roll which is a portion coming in contact with a paper web and transfer thereof is prevented so that the paper roll and the smoother roll is prevented from being contaminated.

### EXAMPLES

Next, spreading experimental results of contamination-preventing agent in the present invention are shown.

### Example 1

In a multi-cylinder dryer type paper machine (manufactured by Kobayashi Engineering Works., Ltd.) such as shown in FIG. 1, after an operation where contamination-preventing agent was continuously supplied and applied to a paper web before entering in a dry part (via the press roll P4 shown in FIG. 1) was performed for 8 hours, a surface state of a dryer (the dryer D1 in FIG. 1) was observed at that time point.

Quality of paper (here, white board paper) produced during the operation was inspected visually.

(Contamination-Preventing Agent Used)

Contamination-preventing agent used here was emulsified aqueous solution (10% concentration, 1.0 g/cc) obtained by mixing vegetable oil, surface active agent and water.

(Spraying Amount)

5 cc/minutes

Incidentally, the emulsified aqueous solution with this amount was diluted with water to 1000 times and spraying was performed at a rate of 1 L/minute.

Here, an area of a paper passing through was 200 m² (paper width: 2 m; making speed: 100 m/minute), and a supply amount of vegetable oil was
5 cc/minute×1.0 g/cc×0.1÷200 m²/minute=0.0025 g/m²=2.5 mg/m².
(Result)

From the result of observation of the dry part after 8 hours elapsed, it was found that there was not any adhesion material on a surface of the cylindrical dryer and the surface appeared as a mirror face.

Further, gloss level on a paper surface was excellent.

### Example 2

In a multi-cylinder dryer type paper machine (manufactured by Kobayashi Engineering Works, Ltd.), after an operation where contamination-preventing agent was continuously supplied and applied to a paper web before entering in a dry part (via the press roll P4t shown in FIG. 1) was performed for 8 hours, a surface state of a dryer was observed at that time point.

In this case, an amount of contamination such as paper fine particles adhered on a dryer surface (the surface of the dryer D1 shown in FIG. 1) was measured.

Incidentally, smaller the value of the amount, more significant the contamination-preventing effect on a surface of a dryer.

Here, the amount of contamination was indicated in an index manner based upon definition that a case where no contamination-preventing agent was adhered on the press roll P4t was 1.

Further, quality of paper (here, a low class printing paper) produced during the operation was inspected visually.

(Spraying Amount)

3 cc/minute

Incidentally, the emulsified aqueous solution with this amount was diluted with water to 4000 times and spraying was performed at a rate of 14 L/minute.

Here, an area of a-paper passing through was 3000 m² (paper width: 4 m; making speed: 750 m/minute), and a supply amount of ampholyte copolymer was
3 cc/minute×1.0 g/cc×0.02÷3000 m²/minute=0.00002 g/m²=0.02 mg/m².
Contamination-Preventing Agent Used

The contamination-preventing agent used here was polymer, and experiment for applying 4 kinds of contamination-preventing agent A, of contamination-preventing agent B, of contamination-preventing agent C, and of contamination-preventing agent D to a paper web was conducted.

Each of the contamination-preventing agents A to D was 2% polymer aqueous solution.

The contamination-preventing agent A was 2 weight % aqueous solution of aqueous polymer mainly containing polymer of cationic monomer and anionic monomer (weight ratio of 5:5), the contamination-preventing agent B was 2 weight % aqueous solution of aqueous polymer mainly containing polymer of cationic monomer and anionic monomer (weight ratio of 8:2), and the contamination-preventing agent C was 2 weight % aqueous solution of aqueous polymer mainly containing polymer of cationic monomer, anionic monomer, and nonionic monomer (weight ratio of 5:2:3).

The contamination-preventing agent D was 2 weight % aqueous solution of aqueous polymer mainly containing cationic monomer.

Here,

The cationic monomer; (meta)acrylic acid 2-(N,N-dimethylamino)ethylbenzylchloride salt

The anionic monomer; methacrylic acid

The nonionic monomer; polyethyleneglycomono (meta)acrylate

As the method for applying these contamination-preventing agents on the press roll, such a method was adopted that each of the contamination-preventing agent described above was diluted with water to 4000 times to be sprayed by the spraying nozzle N shown in FIG. 3, where the application was conducted at a rate of 3 cc/minutes on a concentration solution base.

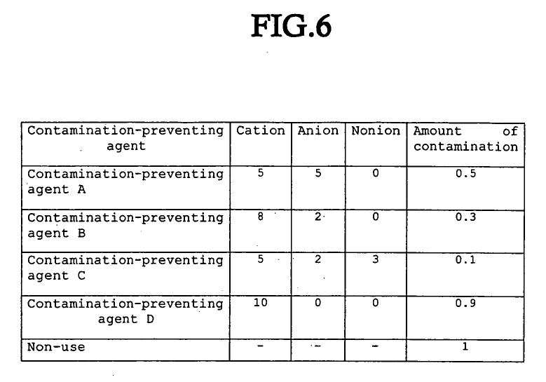

The above experiment result is shown in FIG. 6 (a surface state of the dryer).

(Result)

From the result of observation of the dry part after 8 hours elapsed, it was found that an amount of contamination adhered on the surface of the cylindrical dryer D1 was reduced in each case. Regarding the contamination-preventing agent C, the amount of contamination was reduced down to 1/10 of the case that contamination-preventing agent was not applied to press roll P4t.

A smoothness of a surface of a paper produced during the experiment was excellent.

### Other Examples

The present inventors conducted an experiment which indirectly applied contamination-preventing agent on a paper web via the wire disposed in the wire part and they obtained a similar finding.

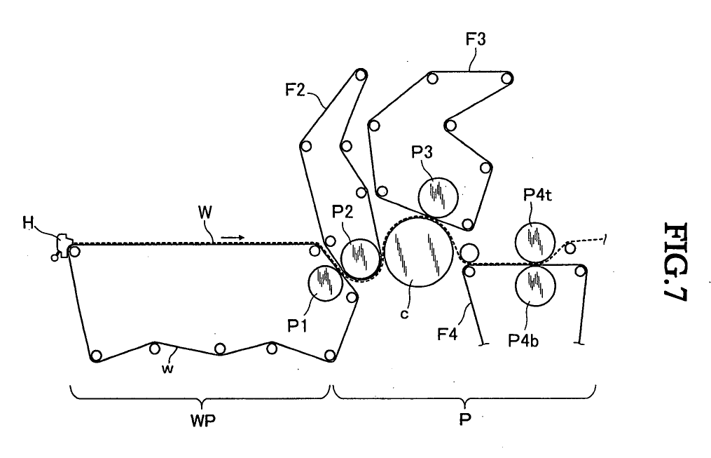

For your reference, the wire part is a region which is positioned upstream of the press part, as shown in FIG. 7.

The wire w is spanned by guide rolls, and slurry-like pulp supplied from a head box H above which is placed on the wire w in a thin film manner and conveyed to the press part.

At that time, water contained in the slurry-like pulp is dehydrated.

Though the present invention has been explained above, the present invention is not limited to these Examples. It goes without saying that the present invention can be modified in various modifications without departing from the essence of the present invention.

The present invention can be sufficiently applied to any portion with which a paper web comes in contact in the dry part, and it is effective for contamination prevention to not only the above-described dryer, canvas and calendar roll but also a paper roll for guiding a paper web or the like, of course.

Besides, the dry part is provided with parts such as a guide roll for a paper web, and the present invention is applicable such parts, of course.

Further, as explained in the second embodiment, the present invention is functionally effective for a roll [that is, the paper roll or the smoother roll (not shown)] in a region which is substantially included in the dry part.

In that case, of course, contamination-preventing agent is continuously supplied and applied to a paper before paper web reaches to the paper roll or the smoother roll.

### INDUSTRIAL APPLICABILITY

The present invention relates to a contamination-preventing method for a dry part in a paper machine, but it is applicable to all the paper-making technical fields without departing from its principle, where a similar effect can be expected.

What is claimed is:

1. A method for preventing contamination of a contacting portion with a paper web in a dry part in a paper machine, where contamination-preventing agent is continuously supplied and applied to a paper web before entering in the dry part.

2. A contamination-preventing method in a dry part according to claim 1, wherein the continuous supplying and applying of the contamination-preventing agent to the paper web is constituted by indirect application to the paper web via an applying roller.

3. A contamination-preventing method in a dry part according to clam 1, wherein the continuous supplying and applying of the contamination-preventing agent to the paper web is constituted by indirect application to the paper web via a guide roller.

4. A contamination-preventing method in a dry part according to claim 1, wherein the continuous supplying and applying of the contamination-preventing agent to the paper web is constituted by indirect application to the paper web via a-felt or a wire.

5. A contamination-preventing method in a dry part according to claim 1, wherein the continuous supplying and applying of the contamination-preventing agent to the paper web is constituted by direct application to the paper web using a spraying nozzle.

6. A contamination-preventing method in a dry part according to claim 1, wherein oil is used as the contamination-preventing agent.

7. A contamination-preventing method in a dry part according to claim 5, wherein the oil is mineral oil, vegetable oil, animal oil, or synthetic oil.

8. A contamination-preventing method in a dry part according to claim 7, wherein as the oil, one obtained by emulsifying oil using surface active agent is used.

9. A contamination-preventing method in a dry part, where polymer is used as the contamination-preventing agent.

10. A contamination-preventing method in a dry part according to claim 9, wherein the polymer serving as the contamination-preventing agent is ampholyte copolymer obtained by polymerizing mixture including cationic monomer having ethylene double bond and anionic monomer having ethylene double bond as essential components.

11. Contamination-preventing agent used in the contamination-preventing method in a dry part according to claim 1, which is obtained by emulsifying mineral oil, vegetable oil, animal oil, or synthetic oil using surface active agent.

12. Contamination-preventing agent used in the contamination-preventing method for a dry part according to claim 1, which is ampholyte copolymer obtained by polymerizing mixture including cationic monomer having ethylene double bond and anionic monomer having ethylene double bond as essential components.

13. Contamination-preventing agent according to claim 12, wherein the cationic monomer is monomer having ethylene double bond with amino groups, ammonium base, or quaternary ammonium base.

14. Contamination-preventing agent according to claim 12, wherein the anionic monomer is monomer having ethylene double bond with carboxyl groups or alkali metal salt thereof.

15. Contamination-preventing agent according to claim 12, wherein the cationic monomer is at least one (including only one, of course) selected from the group consisting of compounds which are (meta)acrylic acid esters such as (meta)acrylic acid 2-(N,N-dimethylamino)ethylmethylchloride salt, (meta)acrylic acid 2-(N,N-dimethylamino)ethylbenzylchloride salt, and (meta)acrylic acid 3-(N,N-dimethylamino)propylepichlorohydrin hydrochloride and which contain quaternry ammonium chlorine.

16. Contamination-preventing agent according to claim 12, wherein the anionic monomer is at least one (including only one, of course) selected from the group consisting of acrylic acid, methacrylic acid, itaconic acid, fumaric acid, succinic acid 2-(meta)acrylicoiloxyethyl, and hexahydrophthalate 2-(meta)acrylicoiloxyethyl.

17. Contamination-preventing agent used for the contamination-preventing method in a dry part according to claim 1, which is ampholyte copolymer obtained by polymerizing mixture including cationic monomer having ethylene double bond, anionic monomer having ethylene double bond, and non-ionic (nonionic) monomer as essential components.

18. Contamination-preventing agent according to claim 17, wherein the cationic monomer is at least one selected from the group consisting of compounds which are (meta)acrylic acid esters such as (meta)acrylic acid 2-(N,N-dimethylamino)ethylmethylchloride salt, (meta)acrylic acid 2-(N,N-dimethylamino)ethylbenzylchloride salt, and (meta)acrylic acid 3-(N,N-dimethylamino)propylepichlorohydrin hydrochloride and which contain quaternry ammonium chlorine.

19. Contamination-preventing agent according to claim 17, wherein the anionic monomer is at least one selected from the group consisting of acrylic acid, methacrylic acid, itaconic acid, fumaric acid, succinic acid 2-(meta)acrylicoiloxyethyl, and hexahydrophthalate 2-(meta)acrylicoiloxyethyl.

20. Contamination-preventing agent according to claim 17, wherein the number of carbon atoms is in a range of 6 to 50 in the non-ionic (nonionic) monomer.

21. Contamination-preventing agent according to claim 17, wherein the non-ionic (nonionic) monomer is polyethyleneglycomono (meta)acrylate and/or polyproplyeneglycolomono(meta)acrylate.

22. A method for preventing contamination of a contacting portion with a paper web in a dry part in a paper machine, wherein contamination-preventing agent is continuously supplied and applied to a paper web before entering in the dry part, and contamination-preventing agent is further continuously supplied and applied to a portion of the dry part which comes in contact with a paper web.

23. A contamination-preventing method for a dry part according to claim 22, wherein the portion of the dry part which comes in contact with a paper web is a dryer, a canvas, a calendar roll, a smoother roll, or a paper roll.

24. Contamination-preventing agent used for a contacting portion with a paper web in a dry part of contamination-preventing agent according to claim 22, which is obtained by emulsifying mineral oil, vegetable oil, animal oil, synthetic oil or wax using surface active agent.
